(19) United States
(12) Patent Application Publication
(10) Pub. No.: US 2009/0129370 A1
(43) Pub. Date: May 21, 2009

(54) Voice-Over-IP Capable Sideshow Device

(76) Inventors: Arman Toorians, San Jose, CA (US); Chung-Yuan Huang, Taipei (TW); Chong-Li Liu, Sanchong City (TW); Yu-Fang Cho, Taipei County (TW); Liang-Chun Chen, Taipei (TW)

Correspondence Address: PATTERSON & SHERIDAN, L.L.P., 3040 POST OAK BOULEVARD, SUITE 1500, HOUSTON, TX, 77056, US

(21) Appl. No.: 11/941,886

(22) Filed: Nov. 16, 2007

(51) Int. Cl. H04L 12/66

(52) U.S. Cl. 370/352

(57) ABSTRACT

A Voice-over-IP capable SideShow device is disclosed. Specifically, according to one embodiment of the present invention, a SideShow device capable of supporting Voice-over-Internet-Protocol (VoIP) includes a modifiable content endpoint and a virtual UART. The content endpoint enables the SideShow device to support a set of configurable functions and associate customized events with the set of configurable functions for the SideShow device to display customized graphical user interface. The virtual UART facilitates the accessing of hardware resources in the SideShow device.

### BACKGROUND OF THE INVENTION

1. Field of the Invention

The present invention relates to Windows SideShow technologies, and more particularly, to a Voice-over-IP capable SideShow device.

2. Description of the Related Art

Unless otherwise indicated herein, the approaches described in this section are not prior art to the claims in this application and are not admitted to be prior art by inclusion in this section.

With Windows Vista operating systems becoming the dominant operating systems for personal computers, a variety of software or hardware applications compatible with Vista-based computer systems are also becoming more and more popular. One of the Vista-based software/hardware applications is Windows SideShow, which is a technology that supports a secondary screen to the Vista-based computer system.

FIG. 1 of a simplified block diagram illustrating a Vista-based computer system 100 having a computing device 102 and a SideShow device 104 connected to the computing device 102 through a wired connection such as the Universal Serial Bus (USB) or a wireless connection such as Bluetooth. The computing device 102 further includes an application program 106, a SideShow gadget 108, and a corresponding SideShow driver 110. The application program 106 is configured to carry out certain functions on the computing device 102 and also generates graphical user interface (GUI) data to send to the SideShow device 104. The SideShow gadget 108 is a mini program that serves as a bridge between the application program 106 and the SideShow device 104. This gadget generally receives events generated by the SideShow device 104 and in response causes the application program 106 to respond to the events. The SideShow driver 110 mainly configures the SideShow device 104 to be operable. The SideShow device 104 further includes a default Simple Content Format (SCF) endpoint 112 for providing certain functions for users of the SideShow device 104 to choose from and also setting up how these functions are presented to users.

In a computer system 100, the computing device 102, rather than the SideShow device 104, is responsible for performing the functions displayed on the SideShow device 104. In other words, actions performed on the part of the Sideshow device 104 are viewed as “events” from the perspective of the computing device 102, and the events are transferred to the application program 106 for processing. Traditionally, the SideShow device 104 supports only a limited number of events. At the same time, how the functions are displayed on the conventional SideShow device 104 is limited as well, since the default SCF endpoint 112 only allows each of the functions to be displayed in a single stripe-like region. These limitations result in the lack of user-friendliness for the conventional SideShow device 104, because interacting with such a device becomes cumbersome and inefficient for users.

To illustrate, suppose the SideShow device 104 is a Voice over Internet Protocol (VoIP) device. At the time a user of this VoIP SideShow device 104 initiates a phone call, the corresponding application program 106 (e.g., a Skype software program) actually dials out the phone number the user inputs on the VoIP SideShow device 104. FIG. 2 is a simplified diagram showing the user interface of a conventional VoIP SideShow device 200. In particular, the VoIP SideShow device 200 includes a display 202 and a control panel 204, which includes an “enter” button 206 and a cross selection key 208 for users of the SideShow device 200 to choose a desired SideShow function for the computing device supporting the SideShow device 200 to perform.

The user interface of the SideShow device 200 shown in FIG. 2 offers limited flexibility. Specifically, the computing device supporting the SideShow device 200 provides all the GUI data, generally in an extensible markup language (XML) text format, for the SideShow device 200. Traditionally, the GUI data can only be displayed in a stripe-like manner as shown in FIG. 2. Further, there is only one “function” (e.g., dial number, make call, take call, or display system information) for one specified stripe area, such as 210, 212, 214, or 216. Once a user selects one of these SideShow functions, the user has no choice but to deal with a pull-down menu 218. To illustrate, after the user selects the “dial number” function (i.e., the stripe area 210) using the enter button 206 and the cross selection key 208, the pull-down menu 218 listing numbers from 0 to 9 is shown for the user to select a phone number to dial using the enter button 206 and the cross selection key 208. Such a dialing session is inconvenient and burdensome.

After the user finishes dialing the phone number, the phone number data is sent to the application program 106 to establish a communication link. With the conventional SideShow device 200 supporting only a limited number of events and not much else, the user of the SideShow device 200 is unable to easily find out the status information associated with the communication link (e.g., whether it is successfully established, whether the call is dropped, and other scenarios).

As the foregoing illustrates, what is needed in the art is an enhanced VoIP SideShow device that addresses at least the problems discussed above.

### SUMMARY OF THE INVENTION

A Voice-over-IP capable SideShow device is disclosed. Specifically, according to one embodiment of the present invention, a SideShow device capable of supporting Voice-over-Internet-Protocol (VoIP) includes a modifiable content endpoint and a virtual UART. The content endpoint enables the SideShow device to support a set of configurable functions and associate customized events with the set of configurable functions for the SideShow device to display customized graphical user interface. The virtual UART facilitates the accessing of hardware resources in the SideShow device.

At least one advantage of the present invention is to enhance the capabilities and functionalities of a SideShow device to support VoIP applications in a more user-friendly and more interactive way.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified block diagram illustrating a computer system having a conventional SideShow device.

FIG. 2 is a schematic diagram showing a conventional SideShow device dialing phone numbers and the graphical user interface (GUI) thereof.

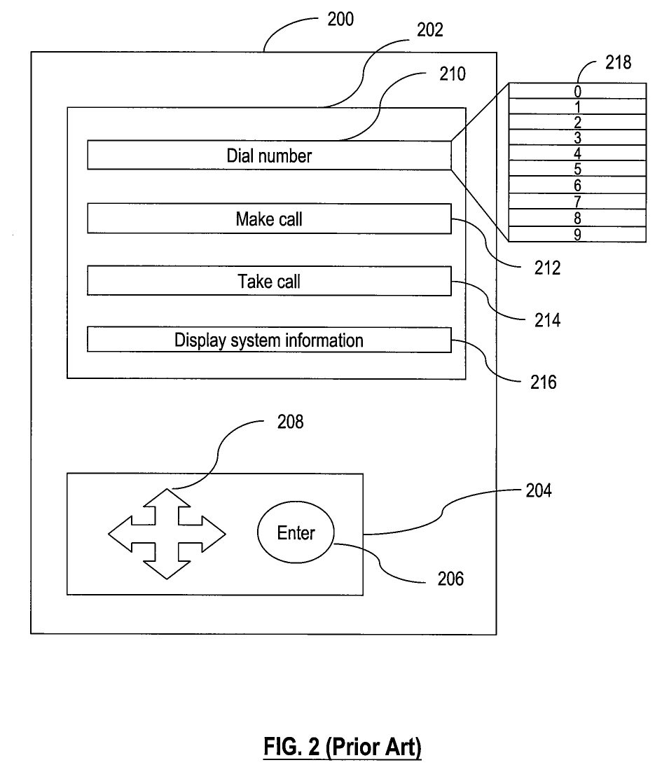

FIG. 3 is a simplified block diagram showing a computer system having a SideShow device according to the present invention.

FIG. 4 is a schematic diagram showing the GUI of the SideShow device according to the present invention.

FIG. 5A is a flow chart illustrating the communication of events between the computing device and the present SideShow device.

FIG. 5B is a flow chart showing the initialization step of the flow chart illustrating the communication of events in FIG. 5A.

### DETAILED DESCRIPTION

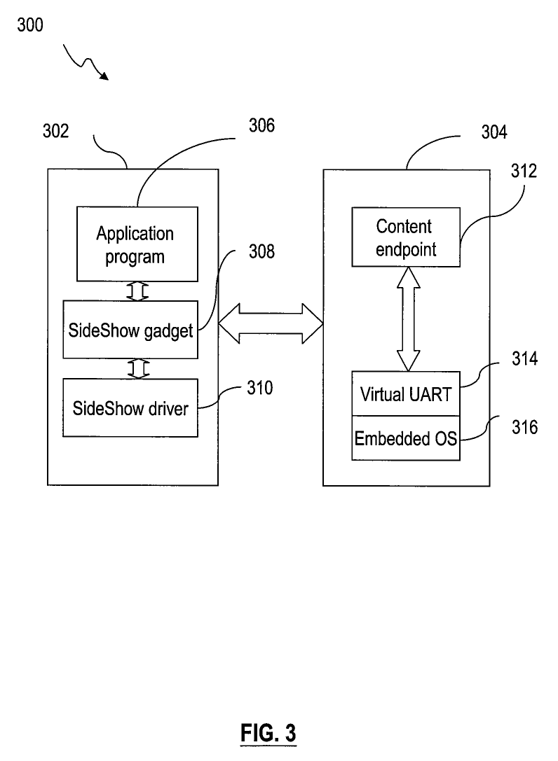

FIG. 3 is a simplified block diagram showing a computer system 300 having a computing device 302 and a SideShow device 304, according to one embodiment of the present invention. The computing device 302 includes an application program 306, a SideShow gadget 308, and a SideShow driver 310. The SideShow device 304 includes a content endpoint 312, a virtual UART 314, and an embedded operating system (OS) 316.

In one implementation, the content endpoint 312 is configured to provide the SideShow device 304 with additional functions by predetermining a set of customized events that the SideShow gadget 308 recognizes. These customized events typically are not provided by the Microsoft-based SCF endpoint. Thus, once the SideShow gadget 308 receives the customized events that are associated with the additional functions, the gadget is able to process the events. With the content endpoint 312 in place, any event could be processed so long as it has been pre-defined and recognized by the SideShow gadget 308.

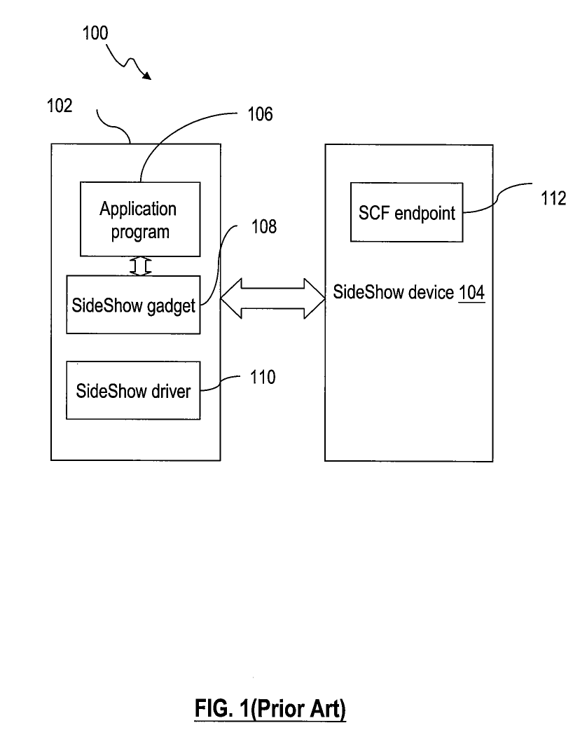

The content endpoint 312 can also be configured to support different GUI on the SideShow device 304. In particular, when the SideShow device 304 is coupled with the computing device 302, the SideShow gadget 308 displays the number of GUIs supported by the SideShow device 304 and allows a user to choose from these different GUI options. For example, the type of GUI supported by the SCF endpoint 112 of FIG. 1 and the content endpoint 312 of FIG. 3 are assigned two different graphical user identification numbers. So, if a user prefers and selects the GUI supported by the content endpoint 312, then in one implementation, the associated graphics user identification number is used to trigger the content endpoint 312 to overwrite the GUI format that the SCF endpoint 112 supports. In one implementation, the content endpoint 312 and the SCF endpoint 112 can co-exist, and the SideShow device 304 thus can support essentially two different types of GUI. The virtual UART 314 is configured to communicate with the embedded OS 316 in order to access the hardware resources of the SideShow device 304 if necessary.

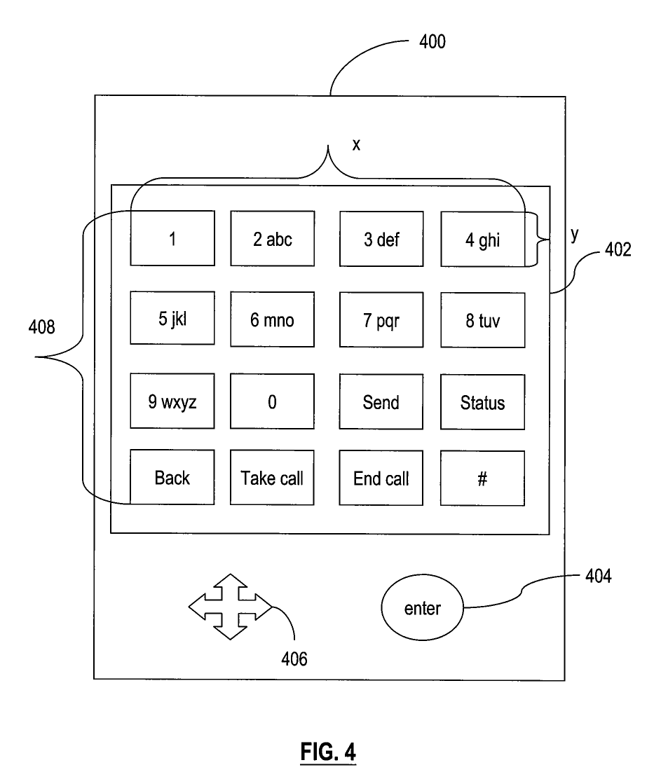

FIG. 4 is a schematic diagram showing the GUI for a SideShow device 400, according to one embodiment of the present invention. The SideShow device 400 here includes a display screen 402, an enter button 404, and a cross selection key 406. Rather than selecting a number with the enter button 404 and the cross selection key 406 as in a convention system as discussed above, in this implementation, the SideShow device 400 enables a user to enter a phone number by simply touching virtual buttons 408 on the display screen 402. In addition to the phone number, the user can also take calls, end calls, or even show the call status by touching the corresponding virtual buttons 408 on the display screen 402. To display more than one icon (e.g., virtual button) in one specified area defined by x and y, the content endpoint and the SideShow gadget need to operate in concert to display such a multi-icon arrangement on the Sideshow device 400. Further, to have the touch-screen capability, an array of touch sensors (not shown) are included underneath the display screen 402, and events corresponding to touching the buttons on the display screen 402 (e.g., take calls, end calls, or show the call status) are pre-defined. Both the content endpoint and the SideShow gadget are configured to support these events.

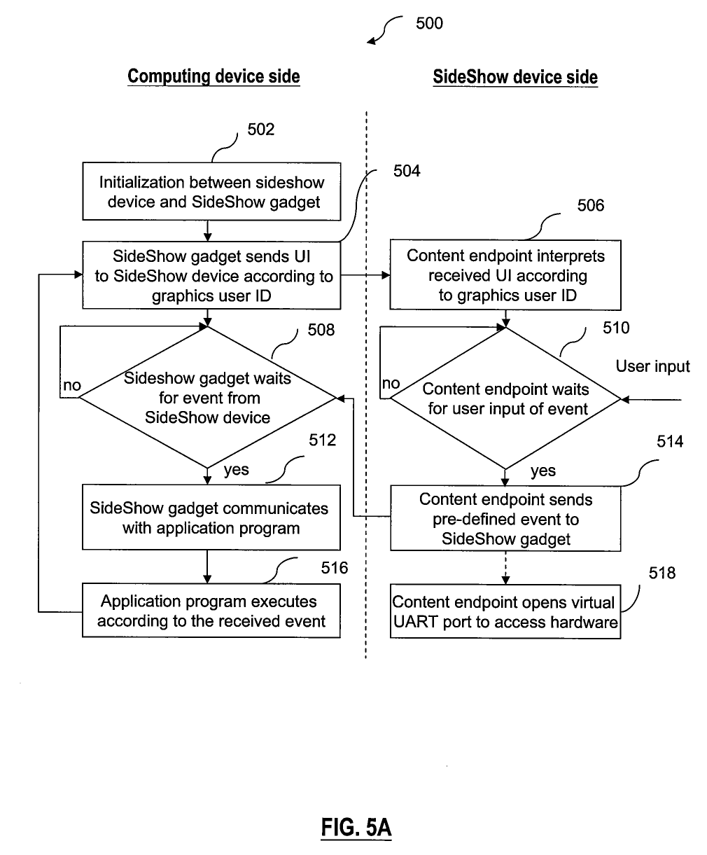

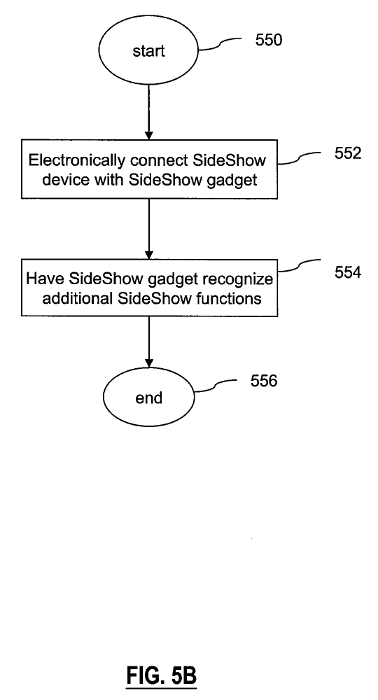

FIG. 5A is a flow chart illustrating a process of communicating events between a computing device and a SideShow device, according to one embodiment of the present invention. Firstly, step 502 is an initiation step, in which the SideShow gadget recognizes and is configured to support all the additional ways the SideShow device is configured to interact with a user. In step 504, the SideShow gadget sends GUI data to the SideShow device according to the graphical user identification numbers. On the SideShow device side, in step 506, the content endpoint interprets the received GUI data according to the graphical user identification numbers so that it is either configured to support with users of SideShow device in the Microsoft default way or others. Both steps 504 and 506 are followed by steps of waiting for events to be inputted (steps 508 and 510). The only difference lies between steps 508 and 510 is step 508 waits for events from SideShow device while step 510 is for the input of event (such as touching the screen button of end call) by users. If steps 508 and 510 fail to have the input of event, such waiting will be continuing. On the other hand, if both steps do have the input of events then both will go to steps 512 and 514, respectively. In step 512, SideShow gadget communicates with the application program which will in turn act on those events, which is represented by step 516 where the application program carries out functions associated with the received events. In step 514, the content endpoint will send those events which have been predefined and recognized by SideShow gadget before to the SideShow gadget. Step 514 further goes to step 508 where the SideShow gadget waits for the input of events from SideShow device. Additionally, step 518 has the content endpoint open virtual USART ports to access hardware, which might be required when the hardware on the part of SideShow device is necessary.

At the time of initiating a phone call over internet protocol, no doubt the event of initiating a call should be recognized by the SideShow gadget before hand in order to ensure the SideShow device could enable the application program (ex. Skype software) to carry out the session of making internet phone calls. During the course of attempting in establishing the communication with the number users just dialed, the GUI could change and such change could be sent to the SideShow device on the basis of its associated graphical user identification number. Then on the SideShow device side the content endpoint interprets the received GUI data arising out of the change to the user interface according to its associated graphical user identification number. Meanwhile, SideShow gadget could wait for event from SideShow device even the communication is still in the making such as an event of ending the call and if that is the case SideShow gadget will communicate with the application program to ask it to end the call. Once the call is terminated, another change to the user interface might take place and such change could also be sent to the SideShow device side to be displayed according to its associated graphical user identification number.

In the case of a phone call coming in, the application program sends a notification of an incoming call to SideShow gadget, which will in turn send another GUI data to the SideShow device so as to notify users thereof of such. Such GUI data (UI) will be sent on the basis of the graphical user identification number of the SideShow device, whose content endpoint will further interpret the GUI data (UI) on the same basis in order to display in a readable form to users of the SideShow device. Once notified, users might choose to take the phone call and such phone call taking is an event from the perspective of the SideShow gadget so long as it has been predefined and recognized by the SideShow device. And the act of taking the call could be achieved by simply touching a button of “take call” on the display in FIG. 4. If users decide to take this incoming call, the event of taking the call will be transferred to the SideShow gadget, which will in turn communicate with the application program to have the latter take the call. Once the application program takes the call, the audio signal processing and transmission falls into any ordinary communication category between two electronic devices whether they are wired together or not.

Generally, incoming calls accompany with ring tones. To have ring tones in order to help notify users of the VoIP capable SideShow device according to the present invention, the presence of the virtual UART is necessary. The primary purpose of the virtual UART is to communicate with the embedded OS of the SideShow device so as to access all the hardware of the SideShow device (such as an internal speaker here) and to play back ring tones to the internal speaker. The ring tone part aside, steps of dealing with incoming calls with ring tones are no different to those handling incoming calls from the computing device.

Please refer to FIG. 5B showing a flow chart illustrating the step 502 in FIG. 5A.
Step 502 in FIG. 5A further includes steps as follows:
Step 550: start;
Step 552: electronically connect the SideShow device and the SideShow gadget;
Step 554: have SideShow gadget recognize additional functions provided by SideShow device; and
Step 556: end.
   The initialization step 502 in FIG. 5A between the SideShow device and the SideShow gadget is to ensure additional ways to interface with users of SideShow device and additional functions are to be recognized by the SideShow gadget. Additional ways to interface with users and additional functions other than ones originally provided by Microsoft are implemented as part of the content end point. And after the SideShow device is electronically connected with the computing device (SideShow gadget) (step 552), the SideShow gadget could determine how many graphical user identifications numbers the SideShow device could accommodate and then could send GUI data (UI) to the SideShow device according to its graphical user identification number. The initialization step 502 further includes a step 554 of having the SideShow gadget recognize additional functions not originally provided. This step could be implemented by modifying the SideShow gadget according to functions provided by content end point. Any additional functions could be obtained only if both the SideShow gadget and the SideShow device (content endpoint) have those functions predefined and recognized.

The above description illustrates various embodiments of the present invention along with examples of how aspects of the present invention may be implemented. One embodiment of the present invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, ROM chips, or any type of solid-state non-volatile semiconductor memory) on which information is permanently stored; and (ii) writable storage media (e.g., floppy disks within a diskette drive, CD-RW disks, DVD-RW disks, flash memory, hard-disk drive, or any type of solid-state random-access semiconductor memory) on which alterable information is stored. The above examples, embodiments, instruction semantics, and drawings should not be deemed to be the only embodiments, and are presented to illustrate the flexibility and advantages of the present invention as defined by the following claims.

We claim:

1. A SideShow device capable of supporting Voice-over-Internet-Protocol (VoIP), comprising:
a modifiable content endpoint to enable the SideShow device to support a set of configurable functions and associate customized events with the set of configurable functions for the SideShow device to display customized graphical user interface; and
a virtual UART to facilitate accessing of hardware resources in the SideShow device.

2. The SideShow device of claim 1, wherein the SideShow device is coupled to a computing device that includes an application program for performing the VoIP functionality and the set of configurable functions.

3. The SideShow device of claim 2, wherein a SideShow gadget recognizes the set of configurable functions before the application program begins to carry out the set of configurable functions.

4. The SideShow device of claim 1, further comprises an embedded operating system (OS) connected with the virtual UART.

5. The SideShow device of claim 1, wherein the SideShow gadget sends graphical user interface data to the SideShow device for display based on the customized events.

6. The SideShow device of claim 5, wherein SideShow device optionally selects a set of default functions supported by Windows Vista based on an identification number associated with the GUI data.

7. The SideShow device of claim 6, wherein the modifiable content endpoint further determines how to display the GUI data according to the identification number.

8. A computer-readable medium containing a sequence of instructions for enabling a SideShow device to support Voice-over-Internet-Protocol (VoIP), which when executed by a processing unit in the SideShow device, causes the processing unit to:
support a set of configurable functions and associate customized events with the set of configurable functions in the SideShow device;
communicate the customized events to a computing device to obtain customized graphical user interface data; and
display the customized graphical user interface data on the SideShow device and optionally access hardware resources in the SideShow device.

9. The computer-readable medium of claim 8, wherein the computing device coupled to the SideShow device includes an application program for performing the VoIP functionality and the set of configurable functions.

10. The computer-readable medium of claim 9, wherein a SideShow gadget recognizes the set of configurable functions before the application program begins to carry out the set of configurable functions.

11. The computer-readable medium of claim 8, further containing sequences of instructions for a content endpoint to support the set of configurable functions and the customized events, an embedded operating system (OS), and a virtual UART to enable the access of the hardware resources.

12. The computer-readable medium of claim 11, further containing a sequence of instructions for the content endpoint, which when executed by the processing unit, causes the processing unit to determine how to display the graphical user interface data according to an identification number.

13. A method for enabling a SideShow device to support Voice-over-Internet-Protocol (VoIP), the method comprises:
supporting a set of configurable functions and associate customized events with the set of configurable functions in the SideShow device;
communicating the customized events to a computing device to obtain customized graphical user interface data; and
displaying the customized graphical user interface data on the SideShow device and optionally access hardware resources in the SideShow device.

14. The method of claim 13, further comprising determining how to display the customized graphical user interface data according to an identification number.
